(19) United States
(12) Patent Application Publication
(10) Pub. No.: US 2003/0058913 A1
(43) Pub. Date: Mar. 27, 2003

(54) CO2 slab laser having electrode assembly including ventilated insulators

(76) Inventors: Christian J. Shackleton, Los Gatos, CA (US); Phillip J. Gardner, Cupertino, CA (US); William Clayton Brand, San Jose, CA (US)

Correspondence Address: STALLMAN & POLLOCK LLP, Atten: Michael A. Stallman, Suite 290, 121 Spear Street, San Francisco, CA, 94105, US

(21) Appl. No.: 09/957,790

(22) Filed: Sep. 21, 2001

(51) Int. Cl. H01S 3/22; H01S 3/223

(52) U.S. Cl. 372/55

(57) ABSTRACT

A CO₂ laser for operation in a repetitive pulsed mode has a slab electrode assembly in which elongated metal electrodes are spaced apart by ceramic insulators attached along aligned edges of the electrodes. An RF potential applied across the electrode causes a discharge in a gas mixture in a gap between the electrodes. At least one aperture extends through each insulator and is aligned with the gap for providing gas movement through the insulator into or out of the gap. Providing the apertures through the insulators increases the maximum pulse repetition frequency of the laser at a given duty cycle compared with that of a similar laser in which the insulators do not have any aperture for providing such gas movement.

### TECHNICAL FIELD OF THE INVENTION

The present invention relates in general to carbon dioxide (CO₂) lasers. The invention relates in particular to minimizing adverse effects of acoustic resonance in CO₂ slab lasers operated in the pulsed mode.

### DISCUSSION OF BACKGROUND ART

CO2 lasers are commonly used in commercial manufacturing for operations such as cutting or drilling, in particular, in nonmetallic materials. One form of CO₂ laser is known to practitioners of the art as a “slab” laser. Such a laser has an assembly including a pair of elongated, slab-like electrodes arranged face-to-face and spaced apart by ceramic insulators to define a gap between the electrodes. The gap is filled with a gas mixture including CO₂ and a radio frequency (RF) potential is applied across the electrodes to cause an electrical discharge in the CO₂ laser gas mixture. A pair of mirrors is arranged, with one thereof at each end of the pair of electrodes, to form a laser resonator. The electrodes form a waveguide or light guide in one axis of the resonator and confine the lasing mode of the resonator in an axis perpendicular to the plane of the electrodes. The mirrors define the lasing mode in an axis parallel to the plane of the electrodes.

A slab laser for drilling, cutting, and other machining operations is usually operated in the pulsed mode. The pulse-repetition frequency (PRF) and the pulse duty-cycle is selected, inter alia, according to the operation to be performed and according to the material on which the operation will be performed. Pulse repetition frequencies selected for drilling, cutting, and machining operations range from less than 1 kilohertz (kHz) to about 100 kHz.

It has been observed that when operating a slab laser at frequencies in a range from about 1 and 10 kHz the laser output can decline at certain frequencies in the range compared with nearby frequencies in the range. It has also been observed that the shape of the output beam of the laser changes as the power declines. It is also possible for the discharge to becomes unstable or even be extinguished altogether.

It is believed that the observed power decline and discharge instability results from perturbations in the gas discharge volume due to localized pressure variations in the gas. These variations cause movement of the discharge within the gap between the slab electrodes. Some of the perturbations appear to be consistent with acoustic resonances in the slab electrode assembly. Generally, available output power increases with increasing gas pressure. Further, when operating in a pulsed-mode faster rise and fall times for the pulses are possible at the higher pressure. Unfortunately, discharge instability due to the above-discussed localized pressure variations also increases with increasing pressure. Minimizing such frequency-dependent effects can expand the usefulness of the slab laser.

### SUMMARY OF THE INVENTION

The present invention is directed to minimizing above described frequency dependent problems in operating slab lasers in a repetitive pulsed mode. In one aspect the invention comprises a laser resonator for a gas laser having an elongated, rectangular, metal electrodes bounding said laser resonator. The metal electrodes are arranged face-to-face and spaced apart, with corresponding opposite pairs of longitudinal edges thereof aligned, defining a gap between the electrodes. The electrodes are spaced apart by a plurality of insulators, at least two thereof attached to one of the pairs of aligned edges, and at least another two thereof attached to the other pair of aligned edges. Each of the insulators has at least one aperture extending therethrough and aligned with the gap.

The electrodes are for supporting an electrical discharge in a lasing gas therebetween. The discharge energizes the gas providing an optical gain medium for the laser resonator. The apertures extending through the insulators allow gaseous communication with the gap through the insulators. It has been found that providing these apertures allows a laser to be operated at a higher pulse repetition rate at a given pulse duty cycle than if the apertures were not provided in insulators otherwise the same.

In one example of a laser in accordance with the present invention, six insulators are attached, spaced apart, along each pair of aligned edges. The insulators have a length of about 30.0 millimeters (mm) and a height of about 30.0 mm. The electrodes have a width of about 44.0 mm and a length of 824.0 mm. The height of the gap between the electrodes of is about 1.9 mm. As such, the total length of electrodes attached to any pair of aligned edges is only about 20% of the length of the edges.

There is one aperture extending through each of the insulators in the form a slot having a length of about 20.0 mm and a height of about 3.0 mm. The maximum pulse repetition frequency (PRF), with a stable discharge, as a function of pulse duty cycle was measured in a range of pulse duty cycle between about 1% and 10%. This measurement was also made in a laser in which the insulators did not have an aperture extending therethrough, the laser and the amount and form of insulators being otherwise identical. Over the entire measurement range, the PRF at a given pulse duty cycle was increased, as a result of providing the apertures in the insulators, by a factor of about 1.7 or greater compared with the PRF in the laser with prior art unslotted insulators. The PRF was increased by more than a factor of 2.0 at duty cycles between 6.5% and 10%. An advantage of a higher PRF at any duty cycle in a slab laser used for laser machining is that higher machining rates are possible at that duty cycle.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a perspective view, partially cut away, schematically illustrating the general arrangement of a prior-art CO₂ slab laser including a pair of elongated, spaced-apart slab electrodes.

FIG. 2 is an exploded perspective view schematically illustrating details of the prior-art electrodes of FIG. 1 and mirrors defining a resonant cavity of the laser.

FIG. 3 is an isometric view schematically illustrating details of a section of the prior-art electrodes of FIG. 2 seen generally in the direction 3-3 of FIG. 2 and spaced apart by prior-art, ceramic insulators.

FIG. 4 is an isometric view schematically illustrating details of the section of prior-art electrodes of FIG. 3 but wherein the electrodes are spaced apart by one preferred example of ventilated ceramic insulators in accordance with the present invention.

FIG. 5 is an isometric view schematically illustrating details of one of the inventive ceramic insulators of FIG. 4 having an elongated pressure-relief slot extending therethrough.

FIG. 6 is a cross-section view seen generally in the direction 6-6 of FIG. 4 and FIG. 7 schematically illustrating further details of the electrode arrangement and inventive ceramic insulators of FIG. 5.

FIG. 7 is an exploded perspective view schematically illustrating details of one embodiment of a slab-laser resonator in accordance with the present invention having an electrode assembly including the inventive ceramic insulators of FIG. 4.

FIG. 8 is a graph schematically illustrating pulse-repetition frequency (PRF) as a function of duty cycle in a prior-art slab laser in accordance with the laser of FIG. 1 and in a similar slab laser in which the slab electrodes are spaced apart by inventive ceramic insulators configured as depicted in FIG. 5.

FIG. 9 is an isometric view schematically illustrating details of another preferred example of a ventilated ceramic insulator in accordance with the present invention having a series of pressure-relief holes extending therethrough.

FIG. 10 is an isometric view schematically illustrating details of yet another preferred example of a ventilated ceramic insulator in accordance with the present invention having two pressure-relief slots extending therethrough.

FIG. 11 is an isometric view schematically illustrating details of a section of ventilated slab electrodes in accordance with the present invention, similar to the electrodes of FIG. 4 but including a series of pressure-relief holes extending through the electrodes in a region thereof adjacent the ceramic insulators.

FIG. 12 is a cross-section view seen generally in the direction 12-12 of FIG. 11 schematically illustrating further details of the inventive electrode arrangement and ceramic insulators of FIG. 10.

### DETAILED DESCRIPTION OF THE INVENTION

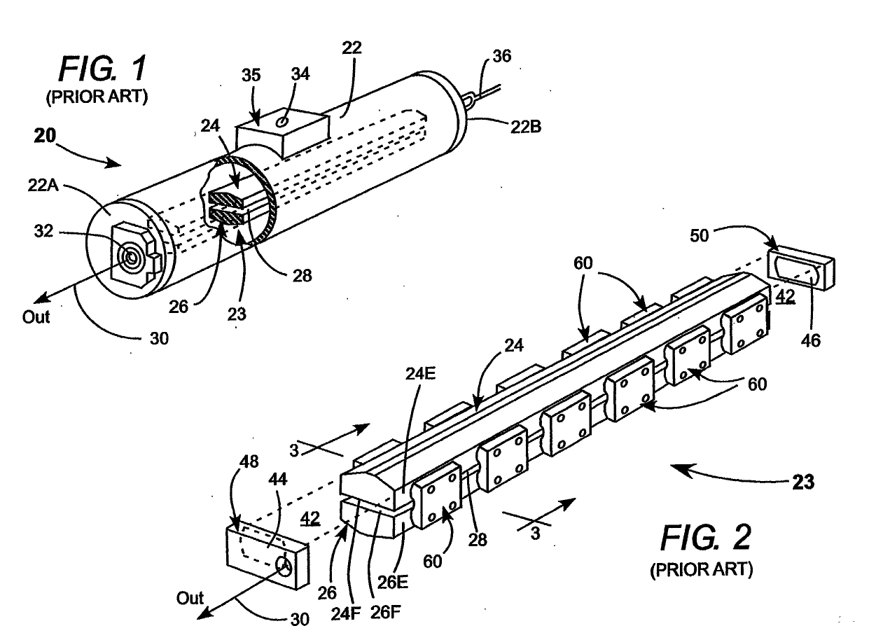

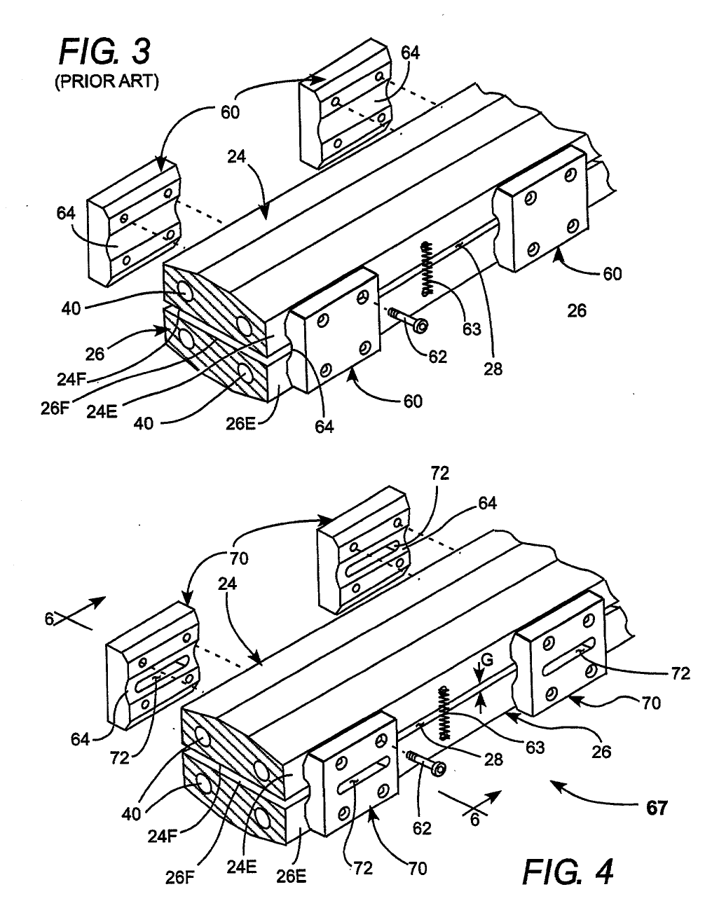

Referring now to the drawings, wherein like features are designated by like reference numerals, FIG. 1, FIG. 2, and FIG. 3 schematically illustrates one example 20 of a prior-art CO₂ slab laser. Laser 20 includes a gas-tight housing 22 that contains the CO₂ lasing gas mixture. Laser 20 includes an electrode assembly 23 including upper and lower slab electrodes 24 and 26 respectively. Electrodes 24 and 26 are arranged with planar faces 24F and 26F, respectively, thereof spaced apart and parallel to each other, defining a gap 28 therebetween. This discharge region has a “slab” shape in cross section, with the narrow axis extending between the electrodes. Applying an RF potential across the electrodes creates an RF gas discharge (not shown) in a laser gas between the electrodes. A laser beam 30 leaves housing 22 via a window 32. An electrical connector 34 is located in a RF matching box 35 on the center of the housing. Connector 34 connects with an electrical feedthrough (not shown) in then matching box. Water-cooling feedthroughs 36 for the electrodes are located at an opposite end 22B of the housing.

As details of electrical connections and water-cooling arrangements well known in the art and are not important for understanding principles of the present invention such details are not described or depicted herein. A detailed description of a laser similar to laser 20 is provided in U.S. Pat. No. 5,140,606, assigned to the assignee of the present invention, and the complete disclosure of which is hereby incorporated by reference.

Referring in particular to FIG. 2 and FIG. 3, electrodes 24 and 26 have planar facing-surfaces 24F and 26F thereof polished sufficiently to be highly reflective for the wavelength of the CO₂ laser radiation, i.e., between about 9.0 and 12.0 micrometers (μm). Water cooling pipes 40 (see FIG. 3) are buried in each of electrodes 24 band 26. A laser resonator 42 is defmed between mirrors 44 and 46 supported on mirror mounts 48 and 50 respectively. These mirrors form an unstable resonator or resonant cavity in the long axis of the slab discharge region. The electrodes are located between the mirrors and bound the cavity which extends through gap 28 between the electrodes. The laser radiation or lasing mode (not shown) is confined in the narrow axis of the slab discharge region perpendicular to the planar faces of the electrodes axis by those faces. This typically termed the waveguide axis. Output beam 30 represents that portion of laser radiation that escapes the unstable resonator as output radiation.

Continuing now with particular reference to FIG. 3 electrodes 24 and 26 are held in the face-to-face, spaced-apart arrangement by a plurality of insulators 60. Preferably these insulators are of a (dielectric) material such as alumina (Al₂O₃). Insulators 60 are spaced apart along pairs of aligned edges 24E and 26E of the electrodes on each side of the electrodes. The insulators are attached to the edges of the electrodes by screws (only one shown in FIG. 3). For completeness of illustration of the electrode assembly, one of a plurality of inductors 63, electrically connecting the electrodes, is depicted in FIG. 3. These inductors form an LC circuit, with the electrodes acting as a capacitor. Such inductors are known in the art to which the present invention pertains. The number and dimensions of the inductors are selected efficient energy transfer into the laser gas mixture from an RF power supply (not shown) connected to the electrodes for applying the RF potential thereto.

In one preferred arrangement, electrodes 24 and 26 have a length of about 825.0 mm and a width of about 44.0 mm. Insulators 60 have a length L of about 30.0 mm and there are six insulators on each side of the electrodes. This results in about twenty-two percent (22%) of the edge of gap 28 being covered by insulators. Each insulator 60 includes a groove 64 such that when insulator is attached to the electrodes groove 64 is adjacent gap 28. This contributes somewhat to preventing confinement of the discharge by the insulators.

The present invention is based on an assumption that although a substantial portion (about 78%) of the edge of gap 28 is not covered by insulators 60, and although the insulators are provided with groove 64 to minimize confinement of the discharge by the insulators, above-discussed acoustic resonant effects can still cause pressure variations in gas in that portion of the discharge located between prior-art insulators 60. It is believed, without being limited to a particular theory, that these localized pressure variations can contribute significantly to the above-discussed power loss and discharge instability at particular pulse repetition frequencies. The present invention comprises modifying insulators of an electrode-insulator assembly in a slab laser to relieve such pressure variations.

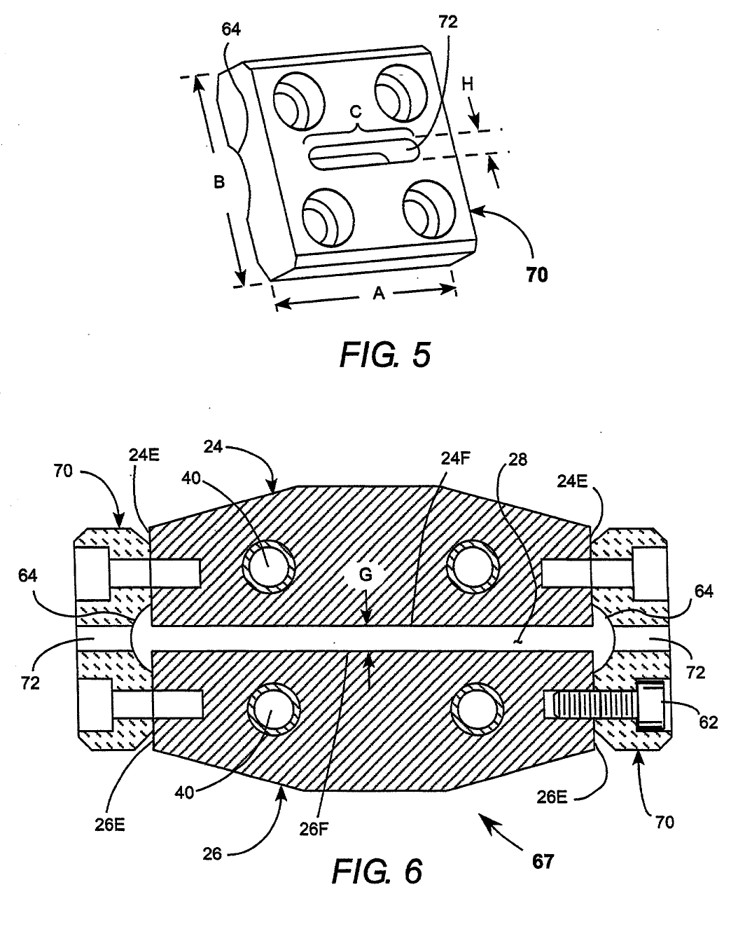

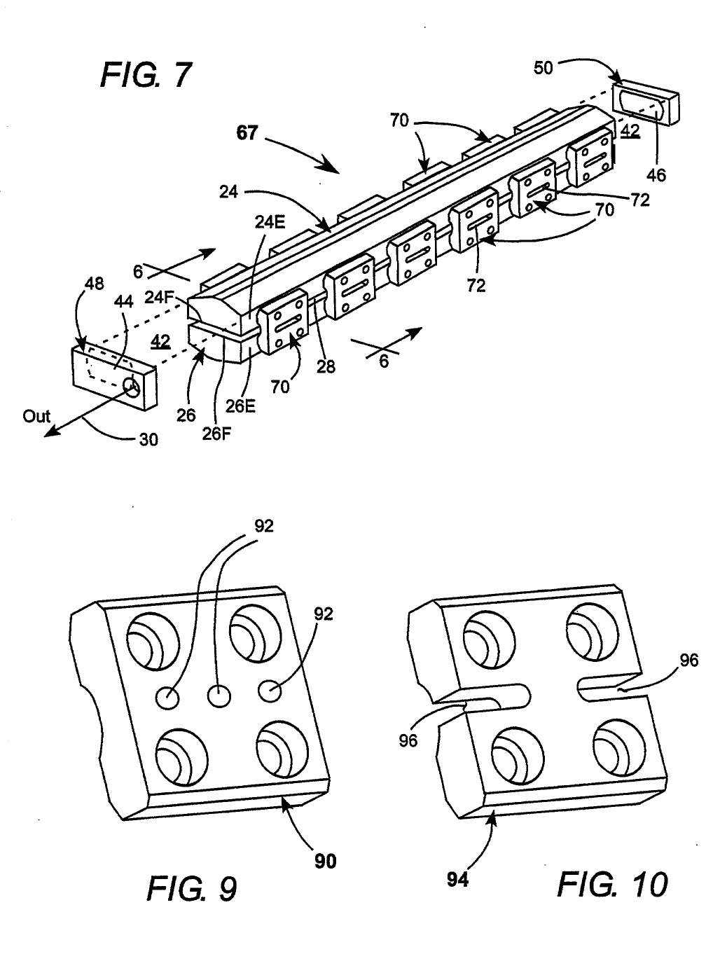

Referring now to FIG. 4, FIG. 5, FIG. 6, and FIG. 7, in one preferred embodiment 67 of an electrode-insulator assembly for a CO₂ slab laser in accordance with the present invention, the laser is arranged similarly to prior-art laser 20 with an exception that slab electrodes 24 and 26 are spaced apart by inventive ceramic insulators arranged to relieve pressure variations due to acoustic resonances in the region of gas discharge between the insulators.

In one preferred embodiment 70 of such an inventive ceramic insulator, the insulator includes an elongated aperture or slot 72 extending through the insulator and arranged such that when the insulator is assembled to electrodes 24 and 26 the slot aligns with gap 28 between the electrodes. This provides that there is fluid (gaseous) communication with the gap through the insulator, i.e., gas in gap 28 adjacent an insulator 70 can move through the insulator for relieving pressure build up. Insulator 70 preferably retains the groove 64 similar to that of prior-art insulator 60. Insulator 70 is attached to edges 24E and 26E of electrodes 24 and 26 via screws 62. The inventive insulator may be referred to as a “ventilated” insulator.

Preferably, slot 72 has a height H at least equal to the height G of gap 28 between electrodes 24 and 26. For an insulator 70 including a groove 64 there may be some advantage to making height H greater than height G. The length of slot 72 is preferably as long as possible consistent with maintaining sufficient mechanical strength of the insulator to support any loads thereon that may occur during operation of the laser. The overall length A and height B (see FIG. 5) of the insulator is determined by mechanical and electrical requirements of the electrode-insulator assembly.

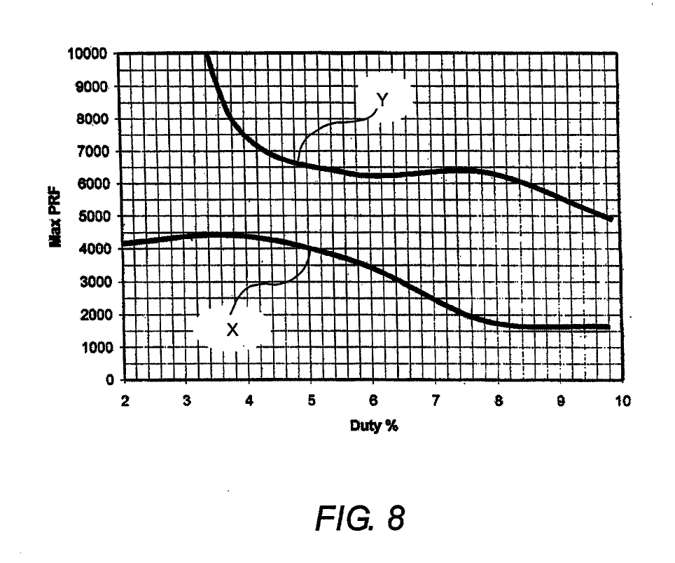

FIG. 8 schematically illustrates maximum pulse repetition frequency (PRF), at stable discharge conditions, as a function of duty cycle for a slab laser wherein electrodes 26 and 28 are spaced apart by prior art ceramic insulators 60 (curve X), and for the slab laser wherein the same electrodes 26 and 28 are spaced apart by inventive slotted ceramic insulators 70 (curve Y). Operating parameters of the lasers such as gas pressure, composition, peak RF power and the like were maintained about the same in each laser. At any duty cycle, increasing the PRF above the value indicated in the graphs is likely to cause discharge instability and may even extinguish the discharge. In each case, the ceramic insulators have a length of about 30.0 mm and a height of about 30.0 mm. Electrodes 26 and 28 each have a width of about 44.0 mm and a length of 824.0 mm. The dimension G of gap 28 between the electrodes is about 1.9 mm.

Slot 72 in ceramic insulators 70 has a length of about 20.0 mm and a height of about 3.0 mm. In each case there are six insulators along each edge of the electrodes. Comparing curves X and Y, it can be seen that that providing slots 72 in insulators 70, at a minimum increases the available PRF by about 1.75 times. At duty cycles between 6.5% and 10% the available PRF is more than doubled. An advantage of the higher PRF at any duty cycle in a slab laser used for laser machining is that higher machining rates are possible.

While an elongated aperture or slot such as slot 72 of insulator 70 is preferred in an insulator in accordance with the present invention, this should not be construed as limiting the invention. One or more apertures having other than a slot-shape may be substituted for the single elongated slot. By way of example, FIG. 9 schematically depicts an inventive insulator 90 having three circular apertures 92 extending therethrough. Apertures 90 are arranged to align with gap 28 between electrodes 24 and 26 when the electrodes are assembled with the insulators. FIG. 10 schematically depicts an inventive insulator 94 having two apertures or slots 96 extending therethrough and extending to the edges of the insulator.

Insulators 70, 90, and 94 described above represent some preferred examples of ventilated insulators in accordance with the present invention. Those skilled in the art may devise other shapes and aperture arrangements of such ventilated insulators without departing from the spirit and scope of the present invention. It should be noted, however, that any other such ventilated insulator arrangement, may not exactly reproduce the result of FIG. 8.

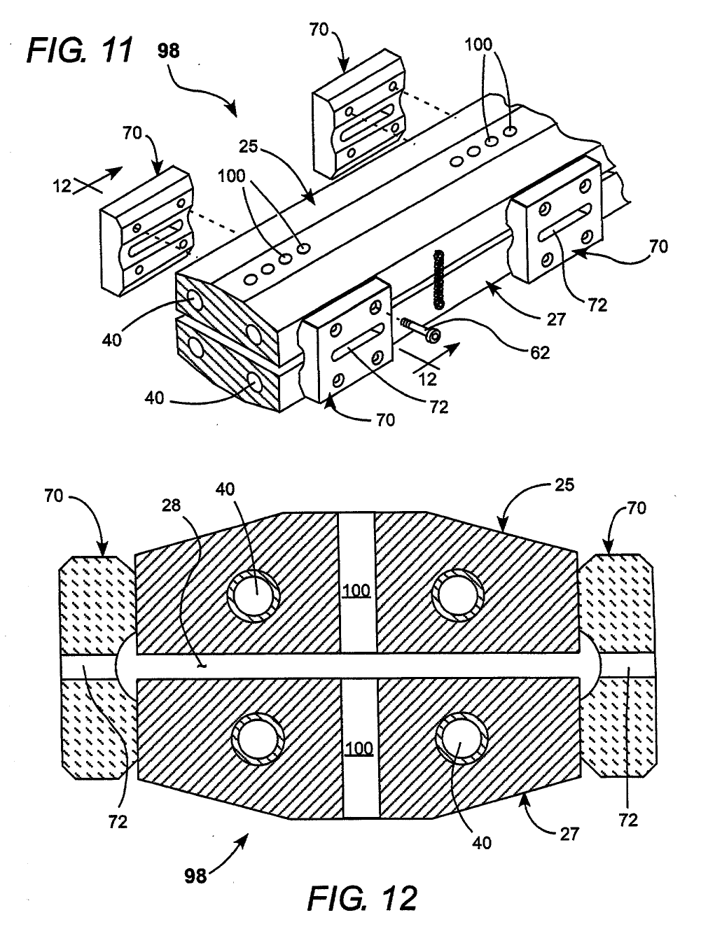

It is believed that the above-discussed, advantageous effect of the inventive, ventilated insulators may be augmented by providing one or more apertures extending through the electrodes, at least between points thereon where insulators are attached. One example of such an electrode-insulator assembly is schematically depicted in FIG. 11 and FIG. 12. Here, an electrode-insulator assembly 98 includes upper and lower electrodes 25 and 27. The electrodes are spaced apart by inventive insulators 70, including slots 72, as described above for electrode-insulator assembly 67 of FIG. 4.

Electrodes 25 and 27 each have a series of circular apertures 100 extending therethrough in a direction perpendicular to the plane of the electrodes. Apertures 100 are located in the electrodes at locations thereon about centrally disposed between attachment locations of insulators 70. Four circular apertures 100 are depicted in each electrode between insulators on opposite edges of electrodes 25 and 27. There are preferably corresponding apertures in each electrode. It is believed that in an acoustic resonance condition the highest pressure in the discharge will be located in gap 28 about midway between edges of electrodes 24 and 26. The arrangement of apertures in electrodes 25 and 27 of FIGS. 11 and 12, however, should be not be considered as limiting the present invention. Those skilled in the art may devise other shapes and locations of apertures without departing from the spirit and scope of the present invention. It should be noted here that while apertures 100 may provide for stable operation at high gas pressures and high pulse repetition rates, some loss of laser power may be experienced due to reduction of the surface area of the electrodes by the apertures. Apertures such as apertures 100 may also provide improvement in maximum pulse repetition rate in electrode-insulator assemblies wherein the electrodes are spaced apart by prior-art insulators such as above-described insulators 60.

The present invention is described above in terms of a preferred and other embodiments. The invention, however, is not limited to the embodiments described and depicted. Rather, the invention is limited only by the claims appended hereto.

What is claimed is:

1. A gas laser, comprising:
a laser resonator;
first and second elongated rectangular, metal electrodes bounding said laser resonator, said metal electrodes arranged face-to-face and spaced apart to define a gap therebetween; and
a plurality of insulators attached to said electrodes for maintaining the spaced apart relationship therebetween and wherein one or more of said insulators includes an aperture extending therethrough and aligned with said gap.

2. The laser of claim 1 wherein each of said insulators includes a plurality of apertures extending therethrough and aligned with said gap.

3. A gas laser, comprising:
a housing including a laser gas;
a laser resonator located in said housing; and
first and second elongated, rectangular, metal electrodes bounding said laser resonator, said metal electrodes arranged with planar faces thereof face-to-face, parallel to each other and spaced apart, and with corresponding opposite pairs of longitudinal edges thereof aligned, defining a gap between said electrodes, said electrodes for energizing the laser gas in the gap such that a laser beam is generated in said resonator, said electrodes being spaced apart by at least four insulators, two thereof attached adjacent to one of said pairs of aligned edges, and the other two thereof attached to the other pair of aligned edges and wherein one or more of said insulators includes at least one aperture extending therethrough and aligned with said gap, for allowing gaseous communication with the gap through said insulator.

4. The laser of claim 3, wherein said aperture is one of a circular aperture and an aperture in the form of an elongated slot.

5. The laser of claim 4, wherein each of said insulators includes only one aperture and said aperture is in the form of an elongated slot.

6. The laser of claim 3 wherein each of said insulators includes a plurality of apertures extending therethrough and aligned with said gap.

7. The laser of claim 6, wherein said apertures are circular.

8. A gas laser, comprising:
a housing including a laser gas;
a laser resonator located in said housing; and
first and second elongated, rectangular, metal electrodes located in said housing and bounding said laser resonator, said metal electrodes arranged with planar faces thereof face-to-face, parallel to each other and spaced apart, and with corresponding opposite pairs of longitudinal edges thereof aligned, defining a gap between said electrodes, said electrodes for energizing the laser gas in the gap such that a laser beam is generated in said resonator, said electrodes being spaced apart by first and second pluralities of ceramic insulators one thereof attached adjacent to one of said pairs of aligned edges, and the other thereof attached adjacent to the other of said pair of aligned edges, and wherein one or more of said insulators includes an aperture in the form of an elongated slot extending therethrough and aligned with said gap, for allowing gaseous communication with said gap through said insulator.

9. The laser of claim 8, wherein there are six insulators in each of said pluralities of insulators.

10. A gas laser, comprising:
a housing including a laser gas;
a laser resonator located in said housing; and
first and second elongated, rectangular, metal electrodes located in said housing and bounding said laser resonator, said metal electrodes arranged with planar faces thereof face-to-face, parallel to each other and spaced apart, and with corresponding opposite pairs of longitudinal edges thereof aligned, defining a gap between said electrodes, said electrodes for energizing the laser gas in the gap such that a laser beam is generated in said resonator and with at least one of the electrodes including a plurality of apertures extending from the gap to the opposite side thereof permitting gaseous communication with said gap.

11. The laser of claim 10, wherein said electrodes are spaced apart by first and second pluralities of ceramic insulators, said first insulators being attached adjacent to one of said pairs of aligned edges, and said second insulators being attached adjacent to the other of said pairs of aligned edges, and wherein one or more of said insulators has at least one aperture extending therethrough and aligned with said gap, for allowing gaseous communication with the gap through said insulator.

12. A gas laser, comprising:
a housing including a laser gas;
a laser resonator located in said housing; and
first and second elongated, rectangular, metal electrodes located in said housing on opposite sides of said laser resonator, said metal electrodes arranged with planar faces thereof face-to-face, parallel to each other and spaced apart, and with corresponding opposite pairs of longitudinal edges thereof aligned, defining a gap between said electrodes, said electrodes for energizing the laser gas in the gap such that a laser beam is generated in said resonator, at least one of said electrodes having a plurality of apertures extending from the gap to the opposite side thereof thereby permitting gaseous communication with said gap, and wherein said electrodes are spaced apart by first and second pluralities of ceramic insulators, the first plurality being attached adjacent to one of said pairs of aligned edges, and the second plurality being attached adjacent to the other of said pairs of aligned edges, one or more of said insulators having at least one aperture extending therethrough and aligned with said gap, for allowing gaseous communication with the gap through said insulator.
